(19) United States
(12) Patent Application Publication
(10) Pub. No.: US 2024/0405596 A1
(43) Pub. Date: Dec. 5, 2024

(54) UNINTERRUPTIBLE POWER SUPPLY AND CAPACITY EXPANSION METHOD THEREOF

(71) Applicant: Shenzhen Chengsheng New Energy Technology Co., Ltd., Shenzhen (CN)

(72) Inventors: SU LUAN, Shenzhen (CN); YI CHEN, Shenzhen (CN)

(21) Appl. No.: 18/341,252

(22) Filed: Jun. 26, 2023

(30) Foreign Application Priority Data
Jun. 5, 2023 (CN) 202310658980.3

(51) Int. Cl. H02J 9/06

(52) U.S. Cl. CPC H02J 9/061; H02J 9/068

(57) ABSTRACT

The present disclosure discloses an uninterruptible power supply and a capacity expansion method for an uninterruptible power supply. The uninterruptible power supply includes a power supply main body, the power supply main body is provided with a built-in battery and a first electrical contact structure electrically connected to the built-in battery; and a capacity expansion battery module detachably connected to the power supply main body, wherein the capacity expansion battery module is provided with a second electrical contact structure; and the capacity expansion battery module is configured to be electrically connected to the first electrical contact structure through the second electrical contact structure, so as to be connected in parallel to the built-in battery.

### CROSS-REFERENCE TO RELATED APPLICATIONS

The application claims priority of Chinese patent application CN2023106589803, filed on 2023 Jun. 5, which is incorporated herein by reference in its entireties.

### TECHNICAL FIELD

The present disclosure relates to the technical field of power supplies, and in particular, to an uninterruptible power supply and a capacity expansion method thereof.

### BACKGROUND

An Uninterruptible Power Supply (UPS), as a backup power supply, has been widely used in data management, hospitals, banks, and other fields. The main purpose is to stabilize voltage and supply uninterrupted power. A UPS is required to have extremely high stability, and has an extremely high requirement for battery packs for power supplying, resulting in a high proportion of battery pack costs. Therefore, a built-in battery pack of a UPS can only provide short-term emergency power supplying to equipment and is not applicable to application scenarios of long-term emergency power supplying.

### SUMMARY

The technical problem to be solved in the present disclosure is to provide an uninterruptible power supply and a capacity expansion method for an uninterruptible power supply, so as to solve the current problem that an uninterruptible power supply cannot be applicable to an application scenario of providing long-term emergency power supplying.

The technical solution adopted by the present disclosure to solve the technical problem is as follows:

The present disclosure discloses an uninterruptible power supply, including:
a power supply main body, wherein the power supply main body is provided with a built-in battery and a first electrical contact structure electrically connected to the built-in battery; and
a capacity expansion battery module detachably connected to the power supply main body, wherein the capacity expansion battery module is provided with a second electrical contact structure; and the capacity expansion battery module is configured to be electrically connected to the first electrical contact structure through the second electrical contact structure, so as to be connected in parallel to the built-in battery.

Further, the capacity expansion battery module includes several stages of first capacity expansion battery packs connected in parallel; the several stages of first capacity expansion battery packs are stacked and are detachably connected to one another; the second electrical contact structure is arranged on the first capacity expansion battery pack at the first stage; and the first capacity expansion battery pack at the first stage is configured to be electrically connected to the first electrical contact structure through the second electrical contact structure, so that the several stages of first capacity expansion battery packs are connected in parallel to the built-in battery.

Further, the capacity expansion battery module includes a second capacity expansion battery pack; the second electrical contact structure is arranged on the second capacity expansion battery pack; and the second capacity expansion battery pack is configured to be electrically connected to the first electrical contact structure through the second electrical contact structure, so as to be connected in parallel to the built-in battery.

Further, the first electrical contact structure is a first capacity expansion interface;
each first capacity expansion battery pack includes a first mounting surface and a second mounting surface which are oppositely arranged; a capacity expansion pin is arranged on the first mounting surface; a second capacity expansion interface is arranged on the second mounting surface; the capacity expansion pin of the first capacity expansion battery pack at the first stage is the second electrical contact structure; and the capacity expansion pin is configured to be plugged to the first capacity expansion interface of the power supply main body or the second capacity expansion interface of the capacity expansion battery pack at the first stage.

Further, the first electrical contact structure is a capacity expansion female socket;
the second electrical contact structure includes:
a wire, wherein one end of the wire is arranged inside the second capacity expansion battery pack and is electrically connected to the built-in battery, and the other end of the wire is arranged outside the second capacity expansion battery pack; and
a capacity expansion male connector, wherein the capacity expansion male connector is arranged outside the second capacity expansion battery pack and is electrically connected to the other end of the wire; and the capacity expansion male connector is plugged to the capacity expansion female socket.

Further, a magnet component is arranged on the first mounting surface of the first capacity expansion battery pack; a first metal component matched with the magnet component is arranged on the second mounting surface; the first capacity expansion battery pack is configured to be magnetically connected to the magnet component of the first capacity expansion battery pack of the next stage through the first metal component;
a second metal component matched with the magnet component is arranged on the surface of the power supply main body provided with the first electrical contact structure; and

the second metal component is configured to be magnetically connected to the magnet component of the first capacity expansion battery pack at the first stage through the second metal component.

Further, the power supply main body includes a main control module; the main control module is electrically connected to the first capacity expansion interface;
the first capacity expansion battery pack includes an electrode assembly, a Low Dropout Regulator (LDO) power supplying module, a communication module, a Battery Management System (BMS) control module, and a switch component;
the LDO power supplying module is electrically connected to the capacity expansion pin and the second capacity expansion interface; the LDO power supplying module is configured to supply a power supplying signal when the capacity expansion battery module is connected to the power supply main body;
the communication module is electrically connected to the LDO power supplying module and the BMS control module respectively; the communication module is configured to be electrically connected to the main control module when the capacity expansion battery module is connected to the power supply main body, and to send battery pack parameters of the first capacity expansion battery pack to the main control module in response to the power supplying signal;
the main control module is configured to: compare the battery pack parameters with a preset condition; when the battery pack parameters satisfy the preset condition, feed back a control instruction to the communication module to send the control instruction to the BMS control module through the communication module; and when the battery pack parameters do not satisfy the preset condition, skip feeding back the control instruction to the communication module;
the BMS control module is electrically connected to the electrode assembly, an input end of the switch component, and a control end of the switch component respectively; an output end of the switch component is electrically connected to the capacity expansion pin and the second capacity expansion interface respectively; the BMS control module is configured to drive, when the control instruction is not acquired, the switch component to be switched off to cut off the electrical connection between the electrode assembly and the built-in battery, and to drive, when the control instruction is acquired, the switch component to be switched on to connect the electrode assembly in parallel to the built-in battery.

Further, the battery pack parameters includes temperature information of the first capacity expansion battery pack;
a temperature sensor is further arranged inside the first capacity expansion battery pack; the temperature sensor is configured to acquire a temperature parameter of the first capacity expansion battery pack; the temperature sensor is electrically connected to the communication module; the temperature sensor is configured to send the temperature parameter to the main control module through the communication module; and
the main control module is configured to compare the temperature parameter with a preset temperature threshold and skip feeding back the control instruction when the temperature parameter exceeds the preset temperature threshold.

Further, the battery pack parameters include a voltage parameter of the first capacity expansion battery pack; and
the main control module is configured to compare the voltage parameter with a preset voltage threshold and skip feeding back the control instruction when the voltage parameter exceeds the preset voltage threshold.

The present disclosure also discloses a capacity expansion method for an uninterruptible power supply, which is applied to the uninterruptible power supply according to any one of as described in above, wherein the capacity expansion method for the uninterruptible power supply includes steps of:
connecting the power supply main body to the capacity expansion battery module, and providing a power supplying signal;
outputting battery pack parameters of the capacity expansion battery packs of the capacity expansion battery module in response to the power supplying signal;
comparing the battery pack parameters with a preset condition; when the battery pack parameters satisfy the preset condition, connecting the capacity expansion battery module in parallel to the built-in battery of the power supply main body; and when the battery pack parameters do not satisfy the preset condition, cutting off the electrical connection between the capacity expansion battery module and the power supply main body.

Beneficial effects: the uninterruptible power supply and the capacity expansion method for an uninterruptible power supply of the present disclosure, in addition to the power supply main body with the built-in battery, the uninterruptible power supply is also provided with the capacity expansion battery module detachably connected to the power supply main body. The capacity expansion battery module is electrically connected to the first electrical contact structure on the power supply main body through the second electrical contact structure of the capacity expansion battery module, so as to be connected in parallel to the built-in battery of the power supply main body, thereby expanding the capacity of the power supply main body. During practical use, a user can add the capacity expansion battery module to increase an available battery capacity to prolong the time of emergency power supplying. Meanwhile, in a case that the built-in battery of the power supply main body is damaged and fails, the power supply main body can still be connected to the capacity expansion battery module to continue to work, which avoids a waste of the power supply main body.

### BRIEF DESCRIPTION OF THE DRAWINGS

FIG. 1 is a schematic structural diagram of an uninterruptible power supply according to a first embodiment of the present disclosure;

FIG. 2 is a schematic structural diagram of a power supply main body according to the first embodiment of the present disclosure;

FIG. 3 is a first schematic structural diagram of a first capacity expansion battery pack according to the first embodiment of the present disclosure;

FIG. 4 is a second schematic structural diagram of a first capacity expansion battery pack according to the first embodiment of the present disclosure;

FIG. 5 is a first schematic structural diagram of a first capacity expansion battery pack according to the first embodiment of the present disclosure;

FIG. 6 is a schematic block diagram of a circuit of the uninterruptible power supply according to the first embodiment of the present disclosure;

FIG. 7 is a schematic structural diagram of an uninterruptible power supply according to a second embodiment of the present disclosure;

FIG. 8 is a first flowchart of a capacity expansion method for an uninterruptible power supply according to a third embodiment of the present disclosure; and

FIG. 9 is a second flowchart of the capacity expansion method for an uninterruptible power supply according to the third embodiment of the present disclosure.

### DETAILED DESCRIPTION OF THE EMBODIMENTS

The present disclosure is further described below in detail in combination with the accompanying drawings and embodiments.

### First Embodiment

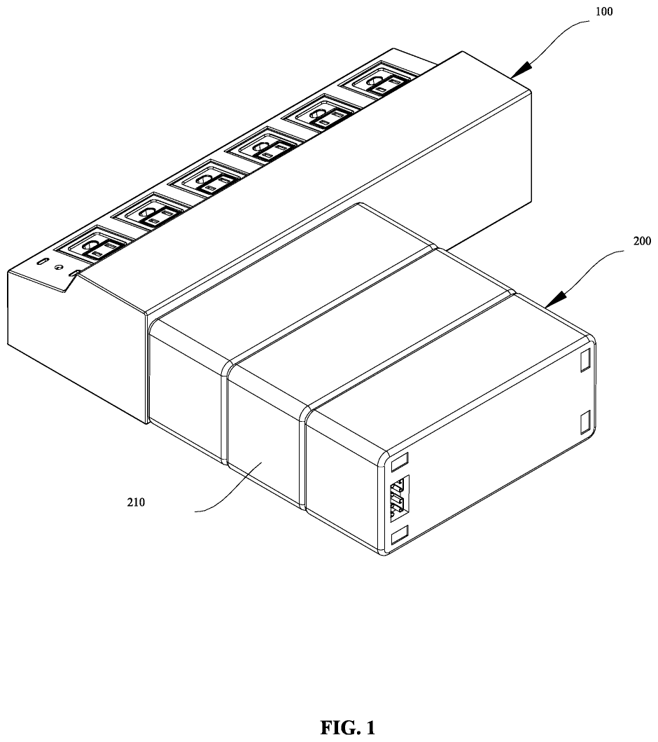

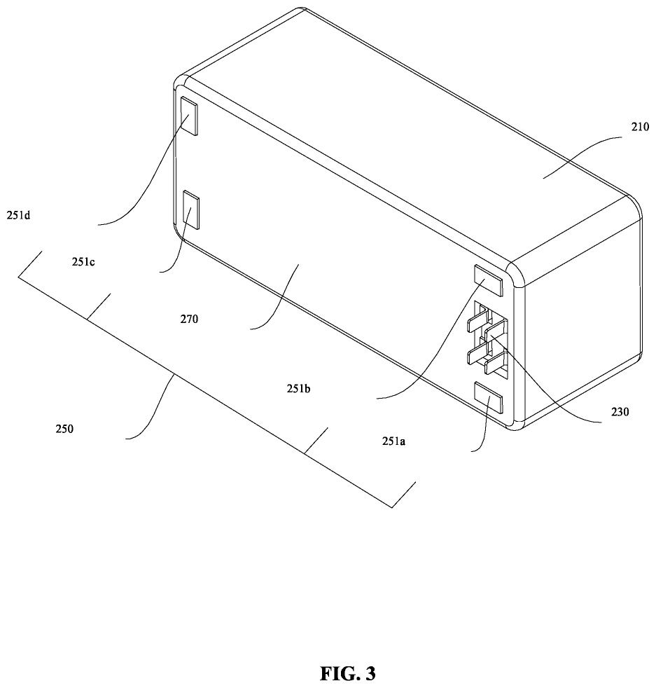

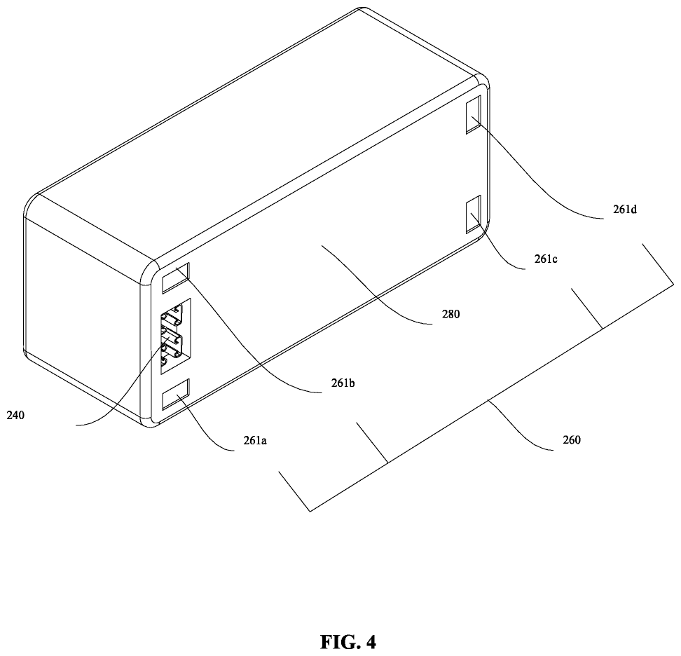

At present, a built-in battery of an uninterruptible power supply on the market can only satisfy an application scenario of short-term emergency power supplying. In order to prolong the time of emergency power supplying and adapt to more application scenarios, referring to FIG. 1 to FIG. 6, this embodiment provides an uninterruptible power supply. Exemplarily, the uninterruptible power supply can be other types of uninterruptible power supplies, such as an extension socket type uninterruptible power supply.

Referring to FIG. 1, the uninterruptible power supply includes a power supply main body 100. The power supply main body 100 is provided with a built-in battery (not shown in the figure) and a first electrical contact structure electrically connected to the built-in battery. The uninterruptible power supply further includes a capacity expansion battery module 200 detachably connected to the power supply main body 100. The capacity expansion battery module 200 is provided with a second electrical contact structure. The capacity expansion battery module 200 is configured to be electrically connected to the first electrical contact structure through the second electrical contact structure, so as to be connected in parallel to the built-in battery.

A working principle of the uninterruptible power supply in this embodiment is as follows: In addition to the power supply main body 100 with the built-in battery, the uninterruptible power supply is also provided with the capacity expansion battery module 200 detachably connected to the power supply main body 100. The capacity expansion battery module 200 is electrically connected to the first electrical contact structure on the power supply main body 100 through the second electrical contact structure of the capacity expansion battery module, so as to be connected in parallel to the built-in battery of the power supply main body 100, thereby expanding the capacity of the power supply main body 100. The built-in battery in this embodiment not only refers to a cell, but also has a complete power supplying circuit, a protection circuit, and the like. Power supplied by the built-in battery is output to the power supply main body 100 via the second electrical contact structure. The power supplying circuit, the protection circuit, and the like can use battery modules in the prior art, and will not be limited here.

It can be understood that during practical use, a user can add the capacity expansion battery module 200 to increase an available battery capacity to prolong the time of emergency power supplying. Meanwhile, in a case that the built-in battery of the power supply main body 100 is damaged and fails, the power supply main body 100 can still be connected to the capacity expansion battery module 200 to continue to work, which avoids a waste of the power supply main body 100. Further, the power supply main body 100 and the capacity expansion battery module 200 are detachably connected, and can be repeatedly used. The capacity expansion battery module 200 can be removed for charging if it runs out of power. At the same time, a new capacity expansion battery module 200 is replaced for capacity expansion, achieving convenient and fast use and high utilization rate.

Continuing to refer to FIG. 1, in some implementations, the capacity expansion battery module 200 includes several stages of first capacity expansion battery packs 210 connected in parallel; the several stages of first capacity expansion battery packs 210 are stacked and are detachably connected to one another; the second electrical contact structure is arranged on the first capacity expansion battery pack 210 at the first stage; and the first capacity expansion battery pack 210 at the first stage is configured to be electrically connected to the first electrical contact structure through the second electrical contact structure, so that the several stages of first capacity expansion battery packs 210 are connected in parallel to the built-in battery.

It can be understood that the first capacity expansion battery pack 210 at the first stage is detachably connected to the power supply main body 100. Among the first capacity expansion battery packs 210 at the remaining stages, the first capacity expansion battery pack 210 at each stage is detachably connected to the first capacity expansion battery pack 210 at the previous stage. This embodiment adopts the several stages of first capacity expansion battery packs 210 that are connected in parallel and detachably, so that the battery capacity of the capacity expansion battery module 200 can be flexibly adjusted. Even if any first capacity expansion battery pack 210 is damaged and fails, only part of expanded capacity is lost, which will not affect the capacity expansion of the power supply main body 100. The stacking of the first capacity expansion battery packs 210 can be sequential arrangement of the first capacity expansion battery packs 210 in an aligned manner, or can be sequential arrangement in a non-aligned manner. In other implementations, a position setting relationship except the stacking can also be adopted, which will not be limited here.

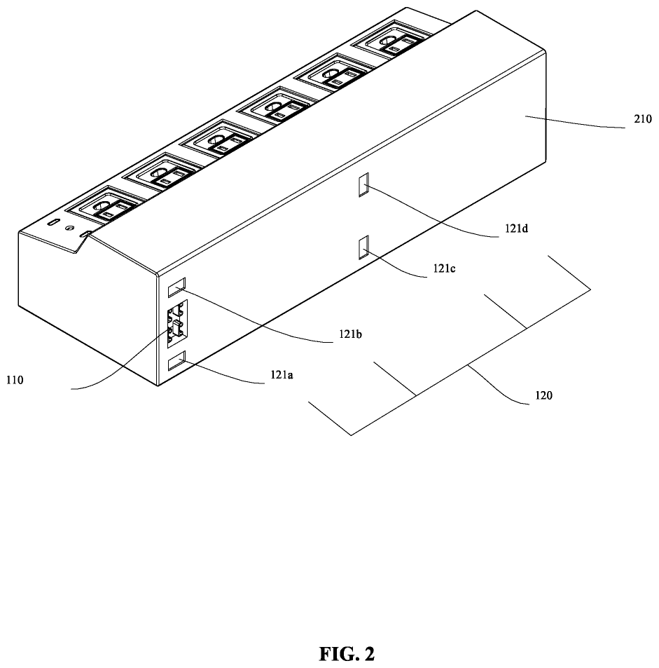

Referring to FIG. 2 to FIG. 4, in some implementations, the first electrical contact structure is a first capacity expansion interface 110. Each first capacity expansion battery pack 210 includes a first mounting surface 270 and a second mounting surface 280 which are oppositely arranged; a capacity expansion pin 230 is arranged on the first mounting surface 270; a second capacity expansion interface 240 is arranged on the second mounting surface 280; the capacity expansion pin 230 of the first capacity expansion battery pack 210 at the first stage is the second electrical contact structure; and the capacity expansion pin 230 is configured to be plugged to the first capacity expansion interface 110 of the power supply main body 100 or the second capacity expansion interface 240 of the capacity expansion battery pack 210 at the first stage.

It can be understood that the first capacity expansion battery pack 210 is plugged to the first capacity expansion interface 110 of the power supply main body 100 through the capacity expansion pin 230 to achieve electrical connection with the power supply main body 100, and is plugged to the capacity expansion pin 230 of the capacity expansion battery pack 210 at the next stage through the second capacity expansion interface 240. The remaining first capacity expansion battery packs 210 are also connected to the capacity expansion pins 230 of the first capacity expansion battery packs 210 at the next stages through the second capacity expansion interfaces 240, so as to be connected into a parallel circuit of the power supply main body 100. In this embodiment, due to the plugging manner of the capacity expansion pins 230, the first capacity expansion interfaces 110, and the second capacity expansion interfaces 240, the electrical connection between the power supply main body 100 and the first capacity expansion battery packs 210 and the electrical connection between the adjacent first capacity expansion battery packs 210 are more stable and reliable. Exemplarily, the capacity expansion pin 230 and the second capacity expansion interface 240 which are located on the same first capacity expansion battery pack 210 are aligned in a body width of the first capacity expansion battery pack, which is favorable for ensuring that the several stages of first capacity expansion battery packs 210 can be tidily stacked and mounted on the power supply main body 100, so that the entire uninterruptible power supply is more beautiful. In other implementations, the capacity expansion pin 230 and the second capacity expansion interface 240 can also be set according to an actual requirement. Correspondingly, the first capacity expansion battery packs 210 can also be arranged in a non-stacked manner, which will not be limited here.

Further, each capacity expansion pin 230 includes a positive pin unit, a negative pin unit, and two communication pin units. The first capacity expansion interface 110 and each second capacity expansion interface 240 are each provided with a positive interface unit, a negative interface unit, and two communication interface units, and are connected to the capacity expansion pin 230 in a one-to-one correspondence manner.

Continuing to refer to FIG. 2 to FIG. 4, in some implementations, a magnet component 250 is arranged on the first mounting surface 270 of each first capacity expansion battery pack 210, and a first metal component 260 matched with the magnet component 250 is arranged on the second mounting surface 280. The first capacity expansion battery pack 210 is configured to be magnetically connected to the magnet component 250 of the first capacity expansion battery pack 210 of the next stage through the first metal component 260. A second metal component 120 matched with the magnet component 250 is arranged on the surface of the power supply main body 100 provided with the first electrical contact structure; and the second metal component 120 is configured to be magnetically connected to the magnet component 250 of the first capacity expansion battery pack 210 at the first stage through the second metal component 120.

It can be understood that this embodiment achieves the detachable connection between the power supply main body 100 and the first capacity expansion battery pack 210 in a magnetic manner, which is favorable for improving the mounting and removal efficiency.

Exemplarily, the first mounting surface 270 is a square surface. The magnet component 250 includes magnet units 251a, 251b, 251c, and 251d separately arranged at various corners of the first mounting surface 270. The first metal component 260 includes first metal units 261a, 261b, 261c, and 261d that correspond to and match the magnet units 251a, 251b, 251c, and 251d in a one-to-one manner. The second metal component 120 includes second metal units 121a, 121b, 121c, and 121d that correspond to and match the magnet units 251a, 251b, 251c, and 251d in a one-to-one manner.

It can be understood that the magnet component 250 of this embodiment is separately arranged at the four corners of the first mounting surface 270. At the same time, the first metal component 260 is provided with the first metal units 261a, 261b, 261c, and 261d that correspond to and match the magnet units 251a, 251b, 251c, and 251d in a one-to-one manner. The second metal component 120 is provided with second metal units 121a, 121b, 121c, and 121d that correspond to and match the magnet units 251a, 251b, 251c, and 251d in a one-to-one manner. When the first capacity expansion battery packs 210 are connected to the power supply main body 100, the four corners of the first capacity expansion battery packs 210 are magnetically fixed, so as to further ensure the stability of connection. Similarly, when the first capacity expansion battery packs 210 are connected to one another, the four corners of the first capacity expansion battery packs 210 at the front and back stages are magnetically fixed one by one, so as to further ensure the stability of connection. The magnet units 251a, 251b, 251c, and 251d are magnetic parts. The first metal units 261a, 261b, 261c, and 261d and the second metal units 121a, 121b, 121c, and 121d all magnetic metal parts, for example, sheet iron.

For another example, end surfaces of the magnet units 251a, 251b, 251c, and 251d are higher than the first mounting surface 270. Corresponding first grooves are formed in positions of the second mounting surface 280 provided with the first metal units 261a, 261b, 261c, and 261d. The first metal units 261a, 261b, 261c, and 261d are arranged in the first grooves. Furthermore, end surfaces of the first metal units 261a, 261b, 261c, and 261d are lower than the second mounting surface 280, so that when the magnet units 251a, 251b, 251c, and 251d are magnetically connected to the first metal units 261a, 261b, 261c, and 261d, the magnet units 251a, 251b, 251c, and 251d are partially accommodated in the first grooves, and the first capacity expansion battery packs 210 at the front and rear stages are connected more reliably. Similarly, second grooves are formed in a surface of the power supply main body 100 provided with the first capacity expansion interface 110. The second metal units 121a, 121b, 121c, and 121d are arranged in the second grooves. End surfaces of the second metal units 121a, 121b, 121c, and 121d are lower than the surface with the first capacity expansion interface 110, so that the first capacity expansion battery pack 210 at the first stage is connected to the power supply main body more reliably.

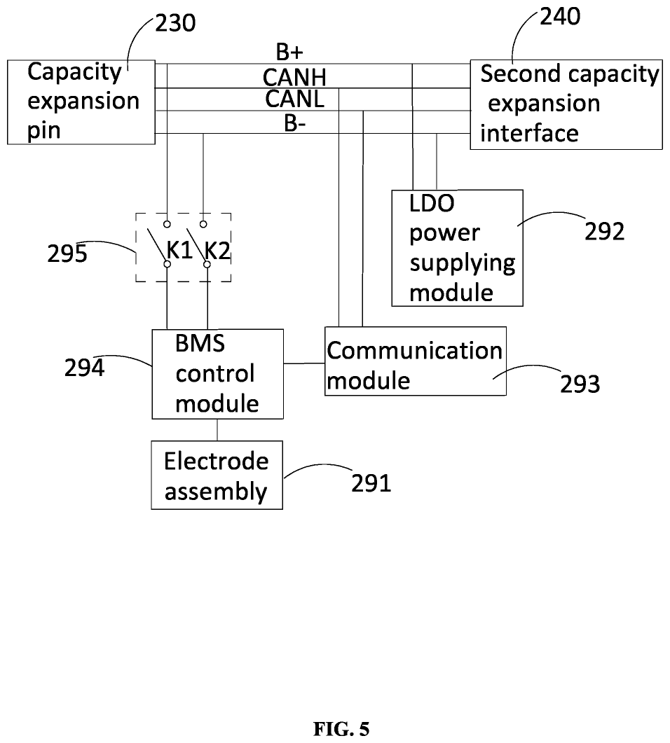

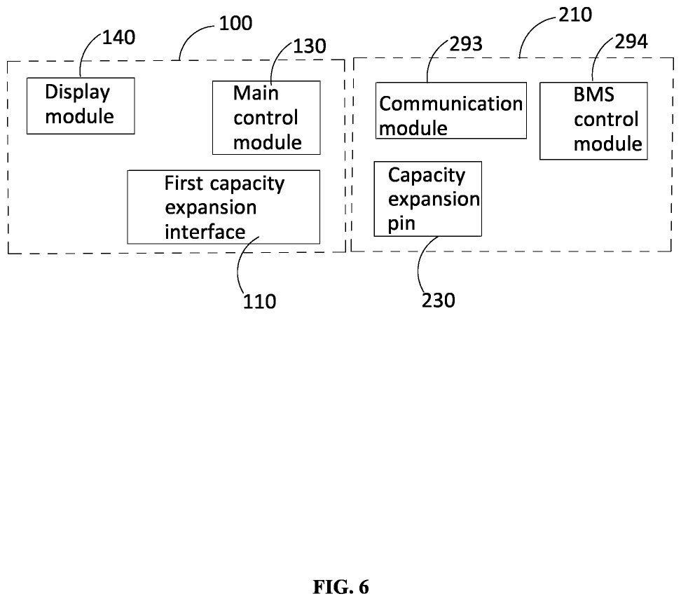

Referring to FIG. 5 and FIG. 6, in some implementations, the power supply main body 100 includes a main control module 130. The main control module 130 is electrically connected to the first capacity expansion interface 110. The first capacity expansion battery pack 210 includes an electrode assembly 291, a Low Dropout Regulator (LDO) power supplying module, a communication module 293, a Battery Management System (BMS) control module, and a switch component 295. The LDO power supplying module 292 is electrically connected to the capacity expansion pin 230 and the second capacity expansion interface 240. The LDO power supplying module 292 is configured to supply a power supplying signal when the capacity expansion battery module 200 is connected to the power supply main body 100. The communication module 293 is electrically connected to the LDO power supplying module 292 and the BMS control module 294 respectively. The communication module 293 is configured to be electrically connected to the main control module 130 when the capacity expansion battery module 200 is connected to the power supply main body 100, and to send battery pack parameters of the first capacity expansion battery pack 210 to the main control module 130 in response to the power supplying signal.

The main control module 130 is configured to: compare the battery pack parameters with a preset condition; when the battery pack parameters satisfy the preset condition, feed back a control instruction to the communication module 293 to send the control instruction to the BMS control module 294 through the communication module 293; and when the battery pack parameters do not satisfy the preset condition, skip feeding back the control instruction to the communication module 293.

The BMS control module 294 is electrically connected to the electrode assembly 291, an input end of the switch component 295, and a control end of the switch component 295 respectively; an output end of the switch component 295 is electrically connected to the capacity expansion pin 230 and the second capacity expansion interface 240 respectively; the BMS control module 294 is configured to drive, when the control instruction is not acquired, the switch component 295 to be switched off to cut off the electrical connection between the electrode assembly 291 and the built-in battery, and to drive, when the control instruction is acquired, the switch component 295 to be switched on to connect the electrode assembly 291 in parallel to the built-in battery.

It can be understood that when the first capacity expansion battery pack 210 is connected to the power supply main body 100, the LDO power supplying module 292 provides the power supplying signal. The communication module 293 sends the battery pack parameters of the first capacity expansion battery pack 210 to the main control module 130 in response to the power supplying signal, so that the main control module 130 compares the battery pack parameters with the preset condition. The battery pack parameters include relevant data of the first capacity expansion battery pack 210, such as an ID, a voltage, a capacity, and a temperature. The preset condition is a preset threshold, a preset value, a preset range, and the like set for the corresponding battery pack parameters, and can be set according to an actual need, which will not be limited here.

Further, when the battery pack parameters satisfy the preset condition, the main control module 130 feeds back the control instruction to the communication module 293, and the communication module 293 sends the control instruction to the BMS control module 294, so that the BMS control module 294 drives the switch component 295 to be switched on to connect the electrode assembly 291 in parallel to the built-in battery, which achieves capacity expansion of the power supply main body 100. When the battery pack parameters do not satisfy the preset condition, the main control module 130 may not feed back the control instruction, and the BMS control module 294 drives the switch component 295 to be switched off when the control instruction is not received, so as to avoid the electrode assembly 291 from being connected into the parallel circuit of the built-in battery. The communication module 293 can adopt a Controller Area Network (CAN) communication module 293. The main control module 130 adopts an existing main control chip. The LDO power supply module 292 adopts an existing module or circuit. Similarly, the BMS control module 294 can adopt an existing module or circuit, which will not be limited here.

Exemplarily, the battery pack parameters include temperature information of the first capacity expansion battery pack 210. A temperature sensor (not shown in the figure) is further arranged inside the first capacity expansion battery pack 210; the temperature sensor is configured to acquire a temperature parameter of the first capacity expansion battery pack 210; the temperature sensor is electrically connected to the communication module 293; the temperature sensor is configured to send the temperature parameter to the main control module 130 through the communication module 293. The main control module 130 is configured to compare the temperature parameter with a preset temperature threshold and skip feeding back the control instruction when the temperature parameter exceeds the preset temperature threshold.

For another example, the battery pack parameters include a voltage parameter of the first capacity expansion battery pack 210. The main control module 130 is configured to compare the voltage parameter with a preset voltage threshold and skip feeding back the control instruction when the voltage parameter exceeds the preset voltage threshold. A voltage detection circuit or detection chip electrically connected to the communication module 293 can be arranged inside the first capacity expansion battery pack 210 to acquire the voltage parameter of the first capacity expansion battery pack 210 and send the voltage parameter to the communication module 293. In some other implementations, a battery management unit in the BMS control module 294 acquires voltage and temperature information of the electrode assembly 291, and sends the voltage and temperature information to the communication module 293, which will not be limited here.

It can be understood that by means of acquiring the temperature information and voltage information of the first capacity expansion battery pack 210, the main control module 130 of this embodiment can turn off the first capacity expansion battery pack 210 when any of the temperature information and the voltage information of the first capacity expansion battery pack is abnormal, so that the uninterruptible power supply is used more safely.

Exemplarily, the switch component 295 can adopt a transistor. In this embodiment, the switch component 295 includes a first transistor K1 and a second transistor K2. An input end and control end of the first transistor are respectively connected to the BMS control module 294. An output end of the first transistor is connected to a positive electrode of the capacity expansion pin 230 and a positive electrode of the second capacity expansion interface 240. An input end and control end of the second transistor are respectively connected to the BMS control module 294. An output end of the second transistor is connected to the positive electrode of the capacity expansion pin 230 and a negative electrode of the second capacity expansion interface 240. The first transistor and the second transistor can adopt a field effect transistor or a triode, which will not be limited here. For another example, the electrode assembly 291 can be formed by combining several cells connected in series or parallel. The several stages of first capacity expansion battery packs 210 can also be separately provided with temperature sensors to acquire a temperature of the first capacity expansion battery pack 210 at each stage.

In some implementations, the power supply main body 100 further includes a display module 140. The display module 140 is electrically connected to the main control module 130. The main control module 130 is further configured to provide abnormality information when the battery pack parameters do not satisfy the preset condition, and to display the information through the display module 140.

It can be understood that in this embodiment, the main control module 130 is further configured to provide the abnormality information when the battery pack parameters do not satisfy the preset condition, and to display the information through the display module 140, so that it is convenient for a user to inquire and confirm the abnormal first capacity expansion battery pack 210. Exemplarily, the abnormality information can be configured to include the ID, electrical parameters, the temperature, and the like of the abnormal first capacity expansion battery pack 210, which will not be limited here. The display module 140 can adopt a liquid crystal display screen or a touch display screen, which will not be limited here.

### Second Embodiment

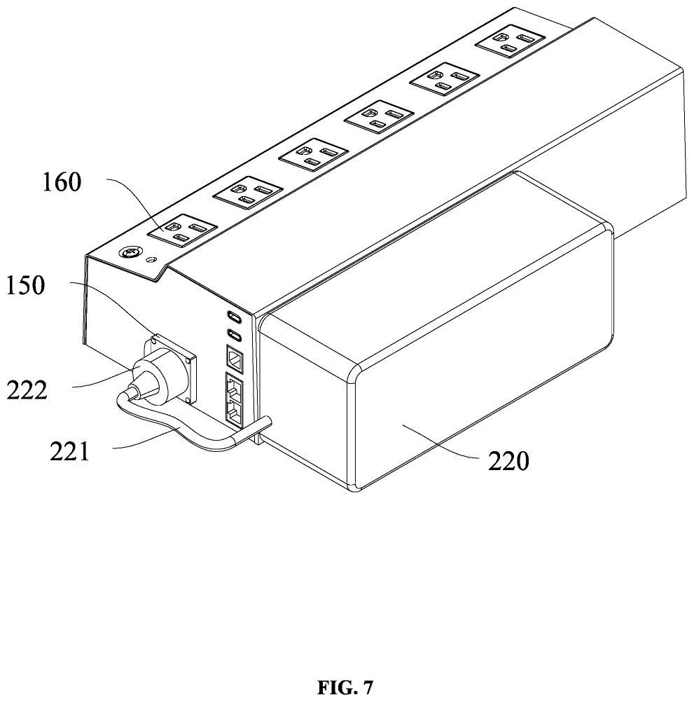

Referring to FIG. 7, this embodiment provides another uninterruptible power supply. A different from the first embodiment is that the capacity expansion battery module 200 of this embodiment includes a second capacity expansion battery pack 220. The second electrical contact structure is arranged on the second capacity expansion battery pack 220. The second capacity expansion battery pack 220 is configured to be electrically connected to the first electrical contact structure through the second electrical contact structure, so as to be connected in parallel to the built-in battery.

It can be understood that the capacity expansion battery module 200 may also adopt a single second capacity expansion battery pack 220. The second capacity expansion battery pack 220 is replaced when it runs out of power or it is damaged. In addition, structures (including a circuit structure) of the second capacity expansion battery pack 220 can be the same as those of the first capacity expansion battery pack 210. In other embodiments, the structures of the first capacity expansion battery pack 210 can be set according to an actual need. Similarly, a battery capacity of a capacity expansion battery pack can be set according to an actual need, which will not be limited here.

Exemplarily, the power supply body 100 and the second capacity expansion battery pack 220 can be electrically connected using a power supply connector. Specifically, the first electrical contact structure is a capacity expansion female socket 150. The second electrical contact structure includes a wire 221. On end of the wire 221 is arranged inside the second capacity expansion battery pack 220 and is electrically connected to the built-in battery. The other end of the wire 221 is arranged outside the second capacity expansion battery pack 220. The second electrical contact structure further includes a capacity expansion male connector 222; the capacity expansion male connector 22 is arranged outside the second capacity expansion battery pack 220 and is electrically connected to the other end of the wire 221; and the capacity expansion male connector 222 is plugged to the capacity expansion female socket 150. The capacity expansion female socket can adopt a three-core female socket. The capacity expansion male connector can adopt a corresponding three-core male connector. In other implementations, other types of the capacity expansion male connector 222 and the capacity expansion female socket 150 can be used according to an actual need.

An extension socket port 160 is arranged on the power supply main body 100. The capacity expansion female socket 150 on the power supply main body 100 can be arranged on a side of a surface with the extension socket port 160, so as to avoid misoperations of a user during use. In addition, a wire length and wire exporting position of the wire 221 located outside the second capacity expansion battery pack 220 can be set according to an actual need, which is convenient for connection between the capacity expansion male connector 222 and the capacity expansion female socket 150. For another example, the second capacity expansion battery pack 220 can adopt the magnetic structure in the first embodiment to achieve detachable mounting, which will not be limited here.

### Embodiment III

This embodiment provides a capacity expansion method for an uninterruptible power supply, which is applied to the uninterruptible power supplies in the first embodiment and the second embodiment, so as to prolong the emergency power supplying time of the uninterruptible power supply.

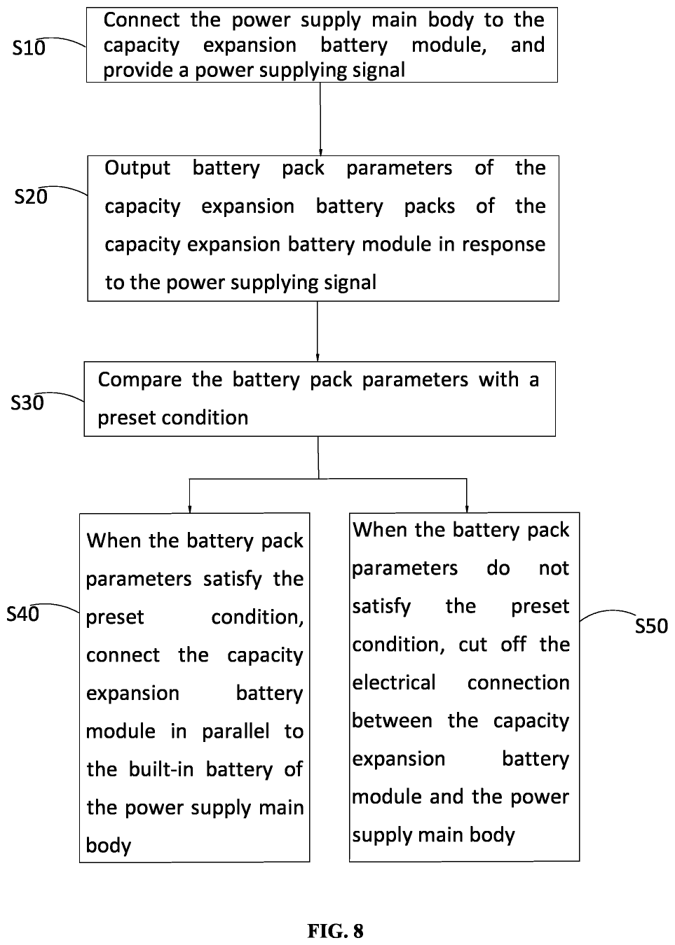

Referring to FIG. 8, the capacity expansion method for an uninterruptible power supply includes steps of:
S10, connecting the power supply main body to the capacity expansion battery module, and providing a power supplying signal;
S20, outputting battery pack parameters of the capacity expansion battery packs of the capacity expansion battery module in response to the power supplying signal;
S30, comparing the battery pack parameters with a preset condition;
S40, when the battery pack parameters satisfy the preset condition, connecting the capacity expansion battery module in parallel to the built-in battery of the power supply main body; and
S50, when the battery pack parameters do not satisfy the preset condition, cutting off the electrical connection between the capacity expansion battery module and the power supply main body.

It can be understood that when the capacity expansion battery module is connected to the power supply main body, the power supplying signal is provided. The battery pack parameters of the capacity expansion battery packs in the capacity expansion battery module are then output in response to the power supplying signal, so as to compare the battery pack parameters with the preset condition. Further, when the battery pack parameters satisfy the preset condition, the capacity expansion battery module is connected in parallel to the built-in battery, expanding the capacity of the power supply main body. When the battery pack parameters do not satisfy the preset condition, the electrical connection between the capacity expansion battery module and the power supply main body is cut off. Due to this setting, it is also favorable for ensuring safety use of a power supply while the capacity of the power supply main body is expanded.

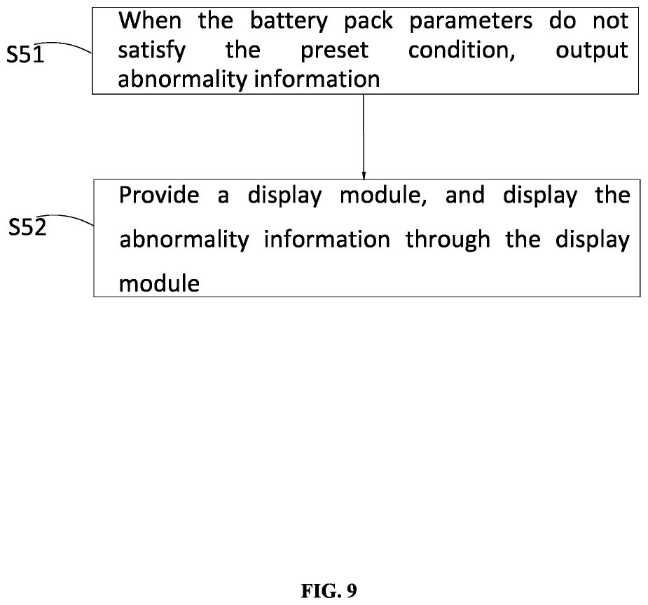

Referring to FIG. 9, in some implementations, step S50 includes:
S51, when the battery pack parameters do not satisfy the preset condition, outputting abnormality information; and
S52, providing a display module, and displaying the abnormality information through the display module.

In this embodiment, when the battery pack parameters do not satisfy the preset condition, the abnormality information is provided, and the abnormality information is displayed through the display module, so that it is convenient for a user to inquire and confirm an abnormal capacity expansion battery pack, thereby ensuring safety use of an uninterruptible power supply.

In summary, according to the uninterruptible power supply and the capacity expansion method for an uninterruptible power supply of the present disclosure, in addition to the power supply main body with the built-in battery, the uninterruptible power supply is also provided with the capacity expansion battery module detachably connected to the power supply main body. The capacity expansion battery module is electrically connected to the first electrical contact structure on the power supply main body through the second electrical contact structure of the capacity expansion battery module, so as to be connected in parallel to the built-in battery of the power supply main body, thereby expanding the capacity of the power supply main body. During practical use, a user can add the capacity expansion battery module to increase an available battery capacity to prolong the time of emergency power supplying. Meanwhile, in a case that the built-in battery of the power supply main body is damaged and fails, the power supply main body can still be connected to the capacity expansion battery module to continue to work, which avoids a waste of the power supply main body.

In addition, the power supply main body and the capacity expansion battery module are magnetically connected, so that they are mounted and removed conveniently. The capacity expansion battery module includes several capacity expansion battery packs, so that the use of the remaining capacity expansion battery packs for capacity expansion will not be affected if some of the capacity expansion battery packs are damaged and fail, and the setting flexibility is high. Meanwhile, the power supply main body can determine states of the capacity expansion battery packs according to voltages and temperatures of the capacity expansion battery packs, so as to control connection or disconnection of the capacity expansion battery packs to or from a parallel circuit, thereby improving the safety of the uninterruptible power supply.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. An uninterruptible power supply, comprising:
a power supply main body, wherein the power supply main body is provided with a built-in battery and a first electrical contact structure electrically connected to the built-in battery; and
a capacity expansion battery module detachably connected to the power supply main body, wherein the capacity expansion battery module is provided with a second electrical contact structure; and the capacity expansion battery module is configured to be electrically connected to the first electrical contact structure through the second electrical contact structure, so as to be connected in parallel to the built-in battery.

2. The uninterruptible power supply according to claim 1, wherein the capacity expansion battery module comprises several stages of first capacity expansion battery packs connected in parallel; the several stages of first capacity expansion battery packs are stacked and are detachably connected to one another; the second electrical contact structure is arranged on the first capacity expansion battery pack at the first stage; and the first capacity expansion battery pack at the first stage is configured to be electrically connected to the first electrical contact structure through the second electrical contact structure, so that the several stages of first capacity expansion battery packs are connected in parallel to the built-in battery.

3. The uninterruptible power supply according to claim 1, wherein the capacity expansion battery module comprises a second capacity expansion battery pack; the second electrical contact structure is arranged on the second capacity expansion battery pack; and the second capacity expansion battery pack is configured to be electrically connected to the first electrical contact structure through the second electrical contact structure, so as to be connected in parallel to the built-in battery.

4. The uninterruptible power supply according to claim 2, wherein the first electrical contact structure is a first capacity expansion interface;
each first capacity expansion battery pack comprises a first mounting surface and a second mounting surface which are oppositely arranged; a capacity expansion pin is arranged on the first mounting surface; a second capacity expansion interface is arranged on the second mounting surface; the capacity expansion pin of the first capacity expansion battery pack at the first stage is the second electrical contact structure; and the capacity expansion pin is configured to be plugged to the first capacity expansion interface of the power supply main body or the second capacity expansion interface of the capacity expansion battery pack at the first stage.

5. The uninterruptible power supply according to claim 3, wherein the first electrical contact structure is a capacity expansion female socket;
the second electrical contact structure comprises:
a wire, wherein one end of the wire is arranged inside the second capacity expansion battery pack and is electrically connected to the built-in battery, and the other end of the wire is arranged outside the second capacity expansion battery pack; and
a capacity expansion male connector, wherein the capacity expansion male connector is arranged outside the second capacity expansion battery pack and is electrically connected to the other end of the wire; and the capacity expansion male connector is plugged to the capacity expansion female socket.

6. The uninterruptible power supply according to claim 4, wherein a magnet component is arranged on the first mounting surface of the first capacity expansion battery pack; a first metal component matched with the magnet component is arranged on the second mounting surface; the first capacity expansion battery pack is configured to be magnetically connected to the magnet component of the first capacity expansion battery pack of the next stage through the first metal component;
a second metal component matched with the magnet component is arranged on the surface of the power supply main body provided with the first electrical contact structure; and the second metal component is configured to be magnetically connected to the magnet component of the first capacity expansion battery pack at the first stage through the second metal component.

7. The uninterruptible power supply according to claim 4, wherein the power supply main body comprises a main control module; the main control module is electrically connected to the first capacity expansion interface;
the first capacity expansion battery pack comprises an electrode assembly, a Low Dropout Regulator (LDO) power supplying module, a communication module, a Battery Management System (BMS) control module, and a switch component;
the LDO power supplying module is electrically connected to the capacity expansion pin and the second capacity expansion interface; the LDO power supplying module is configured to supply a power supplying signal when the capacity expansion battery module is connected to the power supply main body;
the communication module is electrically connected to the LDO power supplying module and the BMS control module respectively; the communication module is configured to be electrically connected to the main control module when the capacity expansion battery module is connected to the power supply main body, and to send battery pack parameters of the first capacity expansion battery pack to the main control module in response to the power supplying signal;
the main control module is configured to: compare the battery pack parameters with a preset condition; when the battery pack parameters satisfy the preset condition, feed back a control instruction to the communication module to send the control instruction to the BMS control module through the communication module; and when the battery pack parameters do not satisfy the preset condition, skip feeding back the control instruction to the communication module;
the BMS control module is electrically connected to the electrode assembly, an input end of the switch component, and a control end of the switch component respectively; an output end of the switch component is electrically connected to the capacity expansion pin and the second capacity expansion interface respectively; the BMS control module is configured to drive, when the control instruction is not acquired, the switch component to be switched off to cut off the electrical connection between the electrode assembly and the built-in battery, and to drive, when the control instruction is acquired, the switch component to be switched on to connect the electrode assembly in parallel to the built-in battery.

8. The uninterruptible power supply according to claim 7, wherein the battery pack parameters comprise temperature information of the first capacity expansion battery pack;
a temperature sensor is further arranged inside the first capacity expansion battery pack; the temperature sensor is configured to acquire a temperature parameter of the first capacity expansion battery pack; the temperature sensor is electrically connected to the communication module; the temperature sensor is configured to send the temperature parameter to the main control module through the communication module; and
the main control module is configured to compare the temperature parameter with a preset temperature threshold and skip feeding back the control instruction when the temperature parameter exceeds the preset temperature threshold.

9. The uninterruptible power supply according to claim 7, wherein the battery pack parameters comprise a voltage parameter of the first capacity expansion battery pack; and
the main control module is configured to compare the voltage parameter with a preset voltage threshold and skip feeding back the control instruction when the voltage parameter exceeds the preset voltage threshold.

10. A capacity expansion method for an uninterruptible power supply, which is applied to the uninterruptible power supply according to claim 1, wherein the capacity expansion method for the uninterruptible power supply comprises steps of:
connecting the power supply main body to the capacity expansion battery module, and providing a power supplying signal;
outputting battery pack parameters of the capacity expansion battery packs of the capacity expansion battery module in response to the power supplying signal;
comparing the battery pack parameters with a preset condition; when the battery pack parameters satisfy the preset condition, connecting the capacity expansion battery module in parallel to the built-in battery of the power supply main body; and when the battery pack parameters do not satisfy the preset condition, cutting off the electrical connection between the capacity expansion battery module and the power supply main body.
